(19) United States
(12) Patent Application Publication
(10) Pub. No.: US 2017/0141724 A1
(43) Pub. Date: May 18, 2017

(54) PHASE CHANGE AND/OR REACTIVE MATERIALS FOR ENERGY STORAGE/RELEASE, INCLUDING IN SOLAR ENHANCED MATERIAL RECOVERY, AND ASSOCIATED SYSTEMS AND METHODS

(71) Applicant: GlassPoint Solar, Inc., Fremont, CA (US)

(72) Inventors: John Setel O'Donnell, Palo Alto, CA (US); Chiaki Treynor, Berkeley, CA (US); Daniel Palmer, Muscat (OM)

(21) Appl. No.: 15/348,880

(22) Filed: Nov. 10, 2016

Related U.S. Application Data
(60) Provisional application No. 62/255,247, filed on Nov. 13, 2015.

(51) Int. Cl. H02S 40/44; F24J 2/34; F28D 20/02; F24J 2/00

(52) U.S. Cl. CPC H02S 40/44; F24J 2/0023; F24J 2/34; F28D 20/02

(57) ABSTRACT

The disclosed technology includes converting solar energy to thermal energy and delivering heat for use in a process. A representative method includes transferring solar energy to a working fluid and transferring energy from the working fluid to a heating element positioned inside a heating well. The heating well contains a thermal energy storage substance (TESS). A controller controls the heating element, which is in thermal communication with the TESS. In some embodiments, the TESS releases and absorbs heat as latent heat, which reduces temperature variation in heat exchange between the heating well and the formation surrounding the heating well. In such embodiments, the TESS is positioned between the heating element and an outer casing of the heating well. In addition to heating wells, the disclosed technology can be applied to other processes involving heat delivery.

### CROSS-REFERENCE TO RELATED APPLICATIONS

The present application claims priority to U.S. Provisional Application No. 62/255,247, filed Nov. 13, 2015, which is incorporated herein by reference.

### TECHNICAL FIELD

The present technology is generally directed to phase change and/or reactive materials for solar enhanced oil recovery and associated systems and methods.

### BACKGROUND

Retorting is a growing industrial process that includes heating oil shale. Oil shale is a fine-grained sedimentary rock containing kerogen. Kerogen can be heated above or below ground as part of the retorting process. At high temperatures, the kerogen in oil shale undergoes a chemical reaction and converts to hydrocarbon gases and liquids. Hydrocarbon gases and liquids are valuable products of the retorting process.

Systems and methods for retorting can be performed ex situ or in situ. In an ex situ process, oil shale is generally heated and treated in vessels aboveground after the oil shale is mined. In an in situ process, oil shale is generally heated underground and the products of the heating process are extracted via production wells. A substantial amount of thermal energy is required for both the ex situ and in situ retorting processes. An ex situ retorting process typically requires approximately 25% of the thermal energy contained in the resulting gas and oil, and an in situ retorting process typically requires approximately 50% of the thermal energy contained in the resulting gas and oil.

FIG. 1 provides an overview of an in situ retorting process in accordance with the prior art. Heating well(s) 1010a-b deliver heat over multiple years into the kerogen-bearing formation(s) 1020a-b (collectively “the formation”). Heating well(s) 1010a-b can heat the formation 1020a-b for a first period of time (e.g., a few years). After heating, production well(s) 1030 deliver the converted/released hydrocarbon products to the surface. While not shown in FIG. 1, both vertical and horizontal wells may be used. The source of heat in the heating wells may be electrical energy (electrical heating elements positioned in the well, powered by electrical generators at the surface) or direct thermal (a heat transfer liquid or gas circulating within the well, heated by facilities on the surface). Also, while not shown in FIG. 1, the heating well(s) 1010a-b can initially heat a formation for several years, and after a period of time, the heating well(s) 1010a-b can be converted to production wells.

The in situ process presents several challenges related to heating the formation 1020a-b. For example, a heating well that does not uniformly heat the formation 1020a-b may lead to undesirable reactions, including excessive coking or undesirable shifts in the average mass of produced hydrocarbon molecules. Inconsistent spatial heat flux may result in both “cold spots,” where conversion reactions do not complete, and “hot spots,” where undesirable reactions take place due to overheating. Similarly, energy sources that create a time-varying heat flux may result in a slower heating time, which delays or reduces hydrocarbon production and/or results in intermittent undesirable reactions.

Utilizing a heating element in a heating well presents several challenges. For example, as shown in FIG. 2, an electrical heating element 2010 may have a resistance that varies along the length of the element. The electrical heating element 2010 may twist, turn, or bend inside the heating well 1010a. The varying resistance along the length of electrical heating element 2010 and distortions in the heating element may cause non-uniform heating, resulting in hot spots. Furthermore, avoiding hot spots poses a particular challenge for the design of electrical heating elements for in situ processes. Most metal alloys used as electrical conductors exhibit a rising electrical resistance with increased temperatures. For example, when locally higher values of thermal energy create hot spots in the heating well, those hot spots may cause further heat non-uniformity due to rising resistance, and thus greater local heat dissipation. This drawback is not limited to electrical heaters, however. Many types of heating elements such as a fluid heating element (e.g., a heated working fluid inside a conduit) can also produce hot and cold spots due to varying thermal contact between the fluid-bearing conduit and the wellbore.

Another challenge associated with the retorting process is identifying an energy source that is cost effective and not detrimental to the environment. One representative solar energy system is shown in FIG. 3. The solar energy system 3000 includes multiple solar collectors 3020 that concentrate incoming solar radiation onto corresponding receivers 3010 (e.g., pipes with a working fluid). The solar collectors 3020 have highly reflective (e.g., mirrored) surfaces that redirect and focus incoming solar radiation onto the receivers 3010. The receivers 3010 receive fluid (e.g., water from a source 3030), which is pressurized and directed to and through the receivers 3010. The water is converted to steam, which is used to directly heat an oil formation, or is converted to electrical energy used for oil recovery and/or other processes. The receivers 3010 and the solar collectors 3020 can be arranged in rows, as shown in FIG. 3. In a particular embodiment, the rows are arranged in a generally east-west configuration so that the solar collectors 3020 generally face toward the equator. The solar energy system 3000 can include drivers (not shown) to vary the angle of the solar collectors 3020 to adjust to daily or seasonal differences of the sun.

With continued reference to FIG. 3, the solar collectors 3020 and receivers 3010 can be housed in an enclosure 3040. The enclosure 3040 can include walls and a roof that provide a boundary between a protected interior region and an exterior region. In particular, the enclosure 3040 can protect the solar collectors 3020 from wind, dust, dirt, contaminants, and/or other potentially damaging or obscuring environmental elements that may be present in the exterior region. At the same time, the enclosure 3040 can include transmissive surfaces, for example, at the walls and/or the roof of the enclosure 3040 to allow solar radiation to pass into the interior region and to the solar collectors 3020. For example, in a particular embodiment, the vast majority of the surface area of the enclosure 3040, including the walls and roof, is made of glass or another suitable transmissive and/or transparent material (e.g., plastic or polymer).

While solar energy can be cost effective and not detrimental to the environment, it presents challenges as an energy source. For example, solar energy is not available at all times and can vary depending on region, time of day, weather, and season. Also, while the arrangement described above with reference to FIGS. 1-3 is suitable for recovering fuel from oil shale and collecting solar energy to use in oil recovery processes, the inventors have identified several techniques that significantly improve the performance of the systems and methods, as discussed in further detail below. Other limitations of existing or prior systems will become apparent to those of skill in the art upon reading the following Detailed Description.

### BRIEF DESCRIPTION OF THE DRAWINGS

FIG. 1 is a partially schematic isometric illustration of an in situ retorting process configured in accordance with the prior art.

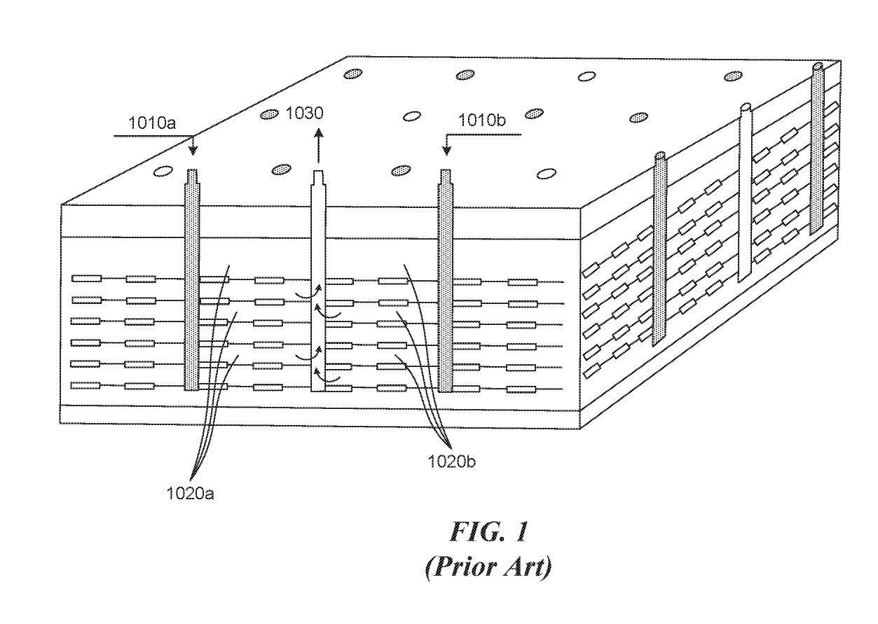

FIG. 2 is a cross-sectional illustration of a portion of a heating well that is used in the in situ retorting process shown in FIG. 1.

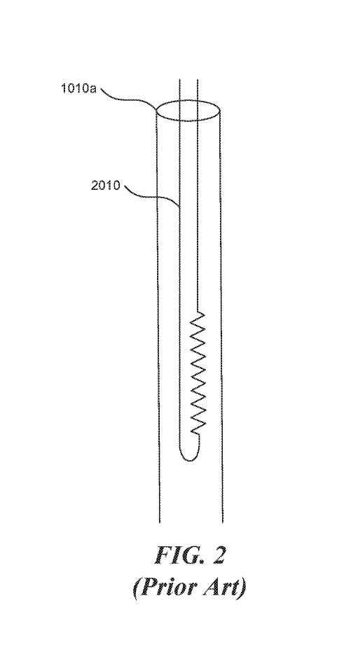

FIG. 3 is a partially schematic isometric illustration of solar collectors that are used to collect solar energy in accordance with the prior art.

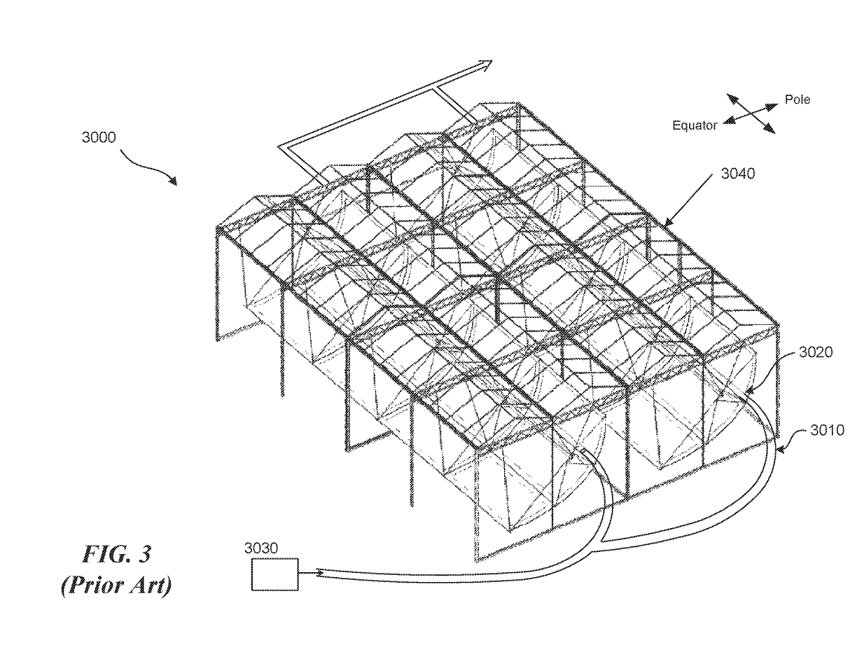

FIG. 4 is a partially schematic block diagram illustrating an environment in which an embodiment of the present technology operates to heat a heating well.

FIGS. 5A-5C illustrate partially schematic, cross-sectional side views of heating wells containing a thermal energy storage substance used to heat formations in accordance with embodiments of the present technology.

FIGS. 6A-6C illustrate partially schematic, cross-sectional top views of a heating well configured in accordance with embodiments of present technology.

FIG. 7A is a partially schematic, cross-sectional side view of a heating well having a thermal energy storage substance configured in accordance with an embodiment of the present technology.

FIG. 7B illustrates a corresponding temperature profile for the heating well shown in FIG. 7A.

FIG. 8A is a partially schematic, cross-sectional top view of a heating well having a thermal energy storage substance undergoing a chemical reaction in accordance with an embodiment of the present technology.

FIG. 8B illustrates a corresponding temperature profile for the heating well shown in FIG. 8A.

FIG. 9 is a graph illustrating results from a simulation of a system configured in accordance with an embodiment of the present technology.

### DETAILED DESCRIPTION

The present technology is generally directed to a relatively isothermal heating process, obtained by inserting a thermal energy storage substance (TESS) into a heat delivery system (e.g., a heating well) and using the heat delivery system to heat the TESS. The process can continue to deliver heat to a formation at isothermal conditions, despite what may be widely varying rates at which the heat is input into the TESS (e.g., due to variations in the availability of solar energy).

The present technology is also directed to non-isothermal heating processes. In non-isothermal embodiments, the heat delivery system can include a TESS that melts over a range of temperatures, e.g., molten salts. Most molten salts are made of a mixture of inorganic salts, solid solutions of which make up a new material which melts over a range of temperatures, as opposed to a single temperature. This can be quite a narrow temperature range especially in the case of eutectic mixtures. However, e.g., if the mixture is not exactly a eutectic mixture, or if there are contaminants, or degradation, or if the heating rate is fast, there will be a range at which melting begins and ends. The melting temperature range can be small (e.g., 1-2 degrees Celsius) or large (e.g., more than 2 degrees Celsius). Further details are disclosed in a report by Judith C. Gomez titled “High-Temperature Phase Change Materials (PCM) Candidates for Thermal Energy Storage (TES) Applications,” available at http://www.nrel.gov/docs/fyllosti/51446.pdf, and incorporated herein by reference.

Whether the phase change occurs at a single temperature or over a range of temperatures (e.g., a limited range), the fact that the material changes phase reduces the temperature variation of the process, and therefore is expected to reduce the existence of hot spots or other thermal variations. Accordingly, as used herein, the term “at least one temperature” includes both a single temperature and a range of temperatures.

The TESS (also referred to herein as a thermal storage substance or energy storage substance) can include a phase change material and/or a material that undergoes a chemical reaction. A phase change generally includes a chemical substance that changes from one phase to another phase (e.g., liquid to solid or vice versa) during normal operation. In one example of a TESS undergoing a phase change, a heating well in an in situ retorting process is at least partially filled with a TESS that has a melting temperature matching or approximating a desired temperature for heating a formation surrounding the heating well. In such an example, the TESS can be located between a casing and a heating element of the heating well. When the TESS is heated to its melting temperature, causing the TESS near the heating element to melt into liquid TESS, the outer solid layer of the TESS delivers heat to the formation through the casing of the heating well.

The TESS can release and absorb heat as latent heat, which is associated with changes in the solid/liquid state of the TESS. For example, during the daytime when solar energy is available, a heating element powered by solar energy can supply enough heat to completely melt the TESS. While the TESS is melting, the solid and liquid phases of the TESS can transfer heat into the formation through conduction and convection in a relatively isothermal manner. If the TESS completely melts while heating, the liquid TESS can transfer heat from the heating well into the formation based on the temperature gradient between the heating element and the temperature of the formation. When the sun wanes or the night begins, the heating element can begin to cool due to loss of solar energy and the TESS can begin to solidify. In some embodiments, the TESS can also release and absorb heat as sensible heat, associated with changes in the temperature of the TESS (e.g., after the TESS has changed phase).

In another example, the TESS is selected based on its chemical reaction properties. A chemical reaction is generally a process that transforms one chemical substance to another. A chemical reaction can occur at single temperature or over a range of temperatures. For example, the TESS may be selected because its chemical reaction or transition temperature (or chemical reaction or transition temperature range) matches or approximates a desired input temperature. In such an example, if the TESS is heated to its chemical reaction or transition temperature (e.g., the temperature at which the endothermic and exothermic reaction rates are balanced, or the temperature at which the forward and backward reactions by which the TESS transitions to another chemical are balanced), a roughly isothermal condition (or, e.g., roughly narrow temperature range condition) can be achieved at least at the outer boundary of the heating well that contains the TESS.

Solar energy can be used to heat a TESS. In some embodiments, photovoltaic (PV) cells can collect solar energy and generate electricity (e.g., current) to power an electrical heating element located in a heating well that contains a TESS. The PV cells can be connected to a controller (e.g., computer) that can regulate a current flowing through an electrical heating element. In this manner, the controller can control the temperature of the TESS inside a heating well. In some embodiments, a processing unit, under the control of the controller, modifies or conditions electrical power electrical power transferred to the electrical heating element.

In other embodiments, solar collectors can collect and concentrate solar energy to heat a working fluid (e.g., a molten salt solution). The working fluid can be connected to a controller that can regulate the flow of the working fluid through a heating well that contains a TESS. The working fluid can be contained in a conduit inside the heating well. In this manner, the controller can control the temperature of the TESS inside a heating well. In some embodiments, a processing unit, under the control of the controller, modifies (e.g., heats) the working fluid transferred to the heating element.

In other embodiments, solar energy and another source of energy are used in combination to heat a heating element in a heating well that contains a TESS. For example, a representative heat delivery system can use electrical power, nuclear power, or power from combustion (e.g., natural gas, oil, and/or coal combustion) in addition to or in place of solar power to heat a heating element. For example, the heat delivery system can use solar energy when it is available (e.g., during the day), and an alternative source of energy (e.g., electrical energy) when solar energy is not available (e.g., at night). In some embodiments, the heat delivery system can store solar energy in another form, for example, in a molten salt or other material in a thermal energy storage tank, and use the energy later for heating the formation. In some embodiments, an administrator can determine which source of energy to use based on several factors, such as cost of an energy source, availability of an energy source, and how an energy source fits in with a particular process. In other embodiments, the selection process is automated.

The TESS can be delivered into a heating well in one or more of several ways. In some embodiments, the TESS can be admitted to the well initially as a bulk solid. In other embodiments, the TESS can be carried into the well in a gaseous suspension. In still further embodiments, the TESS can be delivered to a heating well in a liquid solution or other liquid form. The TESS can have any of a variety of suitable forms and compositions.

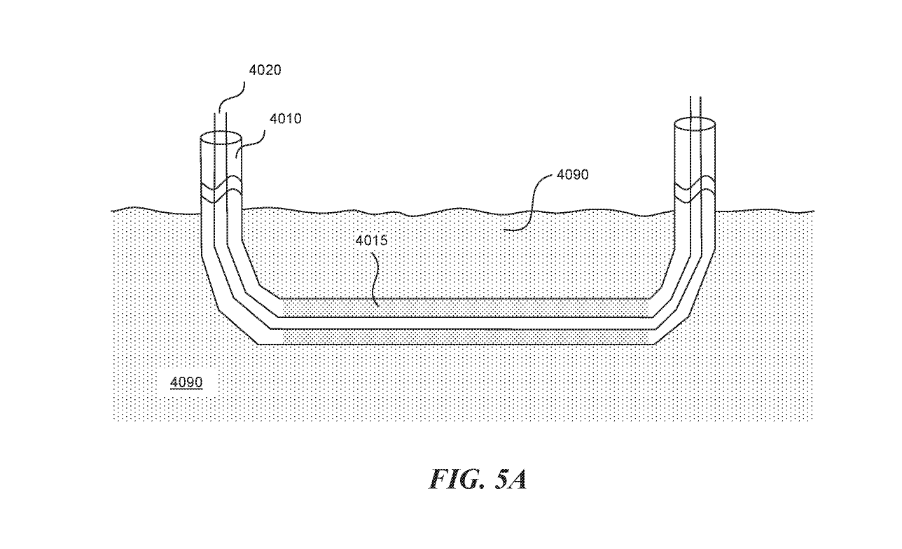

In some embodiments the TESS may be homogeneous, and in others, non-homogeneous. For example, the TESS may be a mixture of a solid and liquid, and the liquid concentration can be modified to increase or decrease the viscosity of the TESS. As another example, the TESS may be a mixture of a gas and liquid, and the gas can diffuse into the liquid, which can result in certain selected chemical properties. In the example well described later with reference to FIG. 5A, for example, pressurized flowing air may be used to carry a finely pelletized solid TESS material into the well, where heat supplied by the heating element causes melting and accumulation in the desired locations. In some embodiments, the TESS may be encapsulated in carrier structures, such as pellets, balls, or other “shell” structures that protect the substance. Suitable encapsulants include organic compounds, ceramics, carbon solids, and other materials durable at the target operating temperatures. In some embodiments, the TESS can be a combination of salts and stabilizer chemicals.

One or more heating elements (which heat the TESS after it is positioned in the well) can be placed in series or parallel with other heating elements. For example, a multitude of parallel heating elements can be distributed along the length of a heating well. In such examples, the heating elements can have “zones” with different resistances (e.g., one heating element can have a high resistance in one part of the well and low resistance in another part of the well; another heating element can have high resistance in the middle of the heating well and low resistance elsewhere). A controller can activate and/or deactivate one or more of the heating elements in order to vary the electrical load. The controller can increase or decrease the power supplied to a particular heating element or elements in order to vary the electrical load. Because the controller can vary the electrical load and because collecting and using solar energy is a variable process (e.g., the amount of solar energy received varies depending on time of day, season, and/or weather), the controller can increase the efficiency of the heating process (e.g., optimize or maximize the efficiency) by adjusting the electrical load to the availability of solar energy (e.g., matching PV cell power output to an electrical load that is optimal for power delivery).

To take advantage of the thermal properties of the TESS, a sufficient amount of TESS is positioned between a heating element and an area to be heated. What is considered a sufficient amount of TESS can depend on several factors. In some embodiments, a sufficient amount of TESS is based on the physical and chemical properties of the heating system. For example, a sufficient of amount of TESS can be based on heat transfer coefficients of the conduit for a heating well, desired temperature of a retorting process (e.g., 250 degrees Celsius), size and shape of the heating well, heat transfer coefficient of the formation, and/or additional characteristics (e.g., heat transfer coefficient of the TESS in its solid state and liquid state and/or thermal conductivity of the heating element). Accordingly, a sufficient amount of TESS is a mass or volume of TESS that when used in the heat delivery system causes the desired heating goals of a process at least based on the factors above.

Aspects of the present technology improve upon the prior art in one or more of several areas. First, the disclosed systems and methods can reduce hot spots, cold spots, and/or excessive temperatures within a formation. Second, the use of solar energy can reduce environmental and financial costs. Third, using solar energy in combination with the TESS can allow for variation in source energy while maintaining nearly isothermal and/or uniform heat flux conditions in the heating well. Fourth, the systems can be combined with other forms of energy, such as natural gas and electricity (from any suitable source, including hydroelectric and nuclear sources), to create a more effective and environmentally sound production environment. Fifth, the system can reduce the use of heat exchangers and insulated storage because solar energy can be transferred from solar collectors to a heating element inside a well, and the well can behave as a heat exchanger. Sixth, the positioning of the TESS between a heating element and a structure (e.g., a wall) of a heating well can enable the chemical and heat transfer properties of the TESS in liquid or solid phase to affect (e.g., regulate) a heat transfer process. Representative processes include the heat transfer between a heating well and adjacent formation, and/or heat transfer in an industrial process.

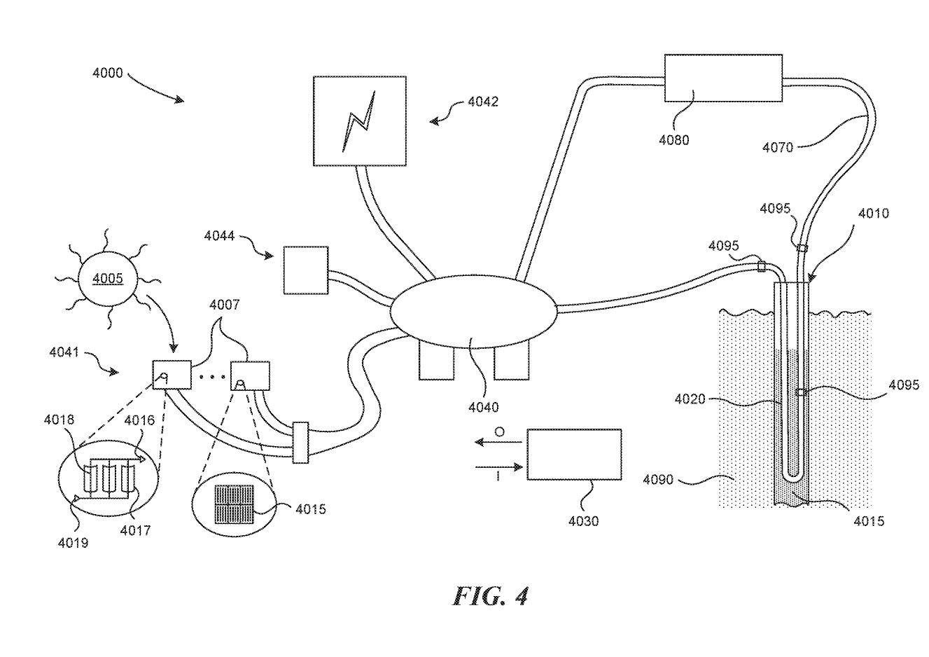

Specific details of several embodiments of the disclosed technology are described below with reference to systems configured for in situ oil recovery. However, the present technology can be used in other processes (e.g., chemical processes, recycling processes, heating processes, solar processes, and/or biomass processes). Other embodiments can also include vertical heating wells, multilateral heating wells, or ex situ retorting process vessels, with heating units either within or outside the process vessels. Moreover, although the following disclosure sets forth several embodiments of different aspects of the presently disclosed technology, several other embodiments of the technology can have configurations and/or components different than those described in this section. Accordingly, the presently disclosed technology may have other embodiments with additional elements and/or without several of the elements described below with reference to FIGS. 4-9.

### Illustrative Environment

FIG. 4 is a partially schematic block diagram illustrating a system 4000 operating in an environment to heat a heating well 4010 in a formation 4090. The system 4000 can include a first energy source 4041 having solar collectors 4007. In some embodiments, solar collectors 4007 include multiple solar concentrators 4017 that concentrate (e.g., via a reflective surface such as a mirror) incoming solar radiation from the sun 4005 onto a corresponding receiver 4018 that carries a working fluid. The receiver 4018 (e.g., conduit or pipe) can have an inlet 4019 and outlet 4016, where the inlet 4019 or outlet 4016 enable the flow of working fluid. In some embodiments, solar collectors 4007 are a flat-plate PV cell 4015 that collects solar radiation. In some embodiments, the system 4000 can have multiple solar collectors 4007, where some solar collectors include solar concentrators with a corresponding receiver carrying working fluid, and other solar collectors include PV cells.

The system 4000 also includes a TESS 4015 inside the heating well 4010. In some embodiments, the heating well 4010 is positioned below a surface and referred to as a “subsurface” heating well. The heating well 4010 can include a heating element 4020. The heating element 4020 can be “at least partially” positioned inside the heating well 4010, wherein at least partially is defined as having the complete heating element 4020 inside the heating well 4020 or having only a portion of the heating element 4020. The heating element 4020 can be connected to a processing unit 4040. The processing unit 4040, under the direction of a controller 4030, directs heat to the heating well 4010.

The processing unit 4040 can also be connected to a second energy source 4042 that supplements or complements the heat provided by the first energy source 4041. When the heating element 4020 carries a working fluid, it can also have an outlet 4070, and the outlet 4070 can be coupled to a recycle unit 4080 (e.g., a heat exchanger or unit that returns the heat transfer flow from the outlet 4070 to the processing unit 4040 after treatment). In other embodiments, the system 4000 has multiple solar collectors 4007, processing units 4040, second energy sources 4042, and/or heating wells 4010.

The processing unit 4040, under the direction of the controller 4030, can control the amount of energy provided by the first energy source 4041 and second energy source 4042 to the heating well 4010 via the heating element 4020 (which can carry a heated fluid or an electrical current). The processing unit 4040 can include a heat exchanger or a combination of heat exchangers. The processing unit 4040 can include process and/or power equipment (e.g., a treatment plant, a system/network of pipes and/or electrical wires, an internal steam generation plant, a monitoring station, a power conditioner, voltage converter, inverter, rectifier, etc.). In some embodiments, through a network of valves, pumps, and conduits containing a working fluid, the processing unit 4040 can control the flow of a working fluid through a heating well and recirculate the working fluid through solar collectors to reheat the working fluid. The processing unit 4040 can run a continuous loop using a controller 4030 as described below (e.g., controlling the flow of the working fluid into a heating well, out of the heating well into a solar collector or heating area, and then back into the heating well). In some embodiments, the process unit 4040 can include or be connected to a storage tank that stores working fluid (e.g., a solution of molten salt). The processing unit 4040 can be configured to heat the storage tank and control the flow of working fluid into and out of the storage tank (e.g., from the storage tank into and out of a heating well).

The system 4000 can include the controller 4030 that receives inputs “I” (e.g., requests and/or sensor data) and delivers outputs “0” (e.g., directives) for controlling the processing unit 4040 and/or other system components. In some embodiments, the controller 4030 can be used to regulate the flow of heated fluid directed to the heating element 4020 in the heating well 4010. The controller 4030 can regulate the fluid flow directly or through a system of valves located along the flow path to the heating element 4020. When the heating element 4020 is an electrically-driven heater, the controller 4030 can regulate the temperature of the heating element by increasing the current and/or voltage supplied to the heating element. In some embodiments, the controller 4030 includes a computing device or multiple computing devices.

In some embodiments, the controller 4030 is configured to control the temperature of the heating element 4020. For example, the controller 4030 can regulate the flow of a heated working fluid or current/voltage in an electrical heating element to adjust the temperature of the heating element to within 0.5 to 10 degrees Celsius of a particular temperature. In some embodiments, the controller 4030 can also regulate the temperature of the heating element to within 5, 10, 15 or 20 degrees Celsius of a particular temperature. The particular temperature can be referred to as a “target temperature”. A target temperature can be a phase change temperature of the TESS (e.g., melting point or melting temperature range), a predetermined temperature (e.g., a requirement to keep an area at or near 100 degrees Celsius), a chemical reaction temperature (e.g., based on Arrhenius's equation and equilibrium constants), and/or a temperature that depends on variables of a process environment (e.g., based on a feedback signal from a temperature sensor). Additionally, the controller 4030 can regulate the temperature of a heating element to be within or near a range of temperatures such a melting temperature range of TESS.

Additionally, in some embodiments, the controller 4030 controls a flow of working fluid directly from the solar collectors 4007 to the heating well 4010, where the flow of working fluid bypasses the processing unit 4040. Similarly, in some embodiments with PV cells as solar collectors 4007, the controller 4030 controls electrical power transfer from the PV cells directly to the heating well 4010 and bypasses the processing unit 4040. Additionally, the controller 4030 can also control electrical power transfer directly from the second energy source 4042 to the heating well 4010 by bypassing the processing unit 4040. One advantage of bypassing the processing unit 4040 is reducing repair and operation costs for the processing unit 4040.

The system 4000 can include one or more second energy source(s) 4042. In some embodiments, the second energy source 4042 can generate thermal energy from a combustion process (e.g., burning coal or oil), which is delivered to the processing unit 4040. In some embodiments, the second energy source 4042 can generate or deliver electrical power to the processing unit 4040. For example, an electrical power plant near the processing unit 4040 can generate and send electrical energy to the processing unit 4040. In other embodiments, several other energy sources (not shown) or combinations of energy sources can direct energy to the processing unit 4040. The second source of energy can include wind, power grid energy (e.g., electrical energy), natural gas, steam, and/or another type of non-solar energy.

Additionally, in some implementations, the processing unit 4040 and/or the controller 4030 can receive information related to cost and availability of the second energy source 4042. For example, the second energy source 4042 can deliver off-peak electrical energy from a grid, where off-peak electrical energy is less expensive than peak electrical energy. The processing unit 4040 and/or the controller 4030 can use this received cost and availability information to decrease (e.g., optimize) cost and increase (e.g., optimize) power supplied to a system or system component (e.g., to a heating well) in an energy efficient manner.

In some embodiments, the processing unit 4040 can include a network of pipes and/or loops. For example, the processing unit 4040 can have or be connected to one loop (e.g., a first loop) of pipes for heating a working fluid that is conveyed through the solar collectors 4007. The processing unit 4040 can include another loop (e.g., a second loop) with a heat transfer fluid, and the processing unit 4040 can transfer heat from one loop to the other loop (e.g., from the working fluid to the heat transfer fluid) using one or more heat exchangers. In some embodiments, the heat transfer fluid can be conveyed to the heating well 4010. In other embodiments, the heat transfer fluid can be used to generate electrical power.

The system 4000 can also include temperature sensors 4095. The temperature sensors 4095 can be used to measure the temperature of the heating elements 4020, the temperature of the TESS 4015, inlet and outlet 4070 temperatures, and/or the temperature of an area (e.g., an area of the formation 4090 near the heating element 4020). The temperature sensors 4095 can transmit temperature measurement information to the controller 4030, the processing unit 4040, and/or a computer used to monitor the system 4000. In some implementations, the system 4000 does not have temperature sensors in the heating well because the well is deep (e.g., more than 25 meters) and the well is heated for extended periods of time at a steady rate. In other embodiments, the temperature of the heating well or formation can be estimated based on the inlet and/or outlet temperatures of working fluid supplied to the heating well or the amount of power used to power an electrical heating element. Other variables or inputs can be used to estimate the temperature of the formation or the heating well, including the estimated concentration and density of material in the formation nearing the heating well and the amount of heat that is entering the heating well.

The system 4000 can also include batteries 4044. The batteries 4044 can be used to store energy received from the solar collectors 4007 and/or the second source of energy 4042. For example, a PV cell can be coupled to a battery, and the battery can store power. In some embodiments, the processing unit 4040, under the direction of the controller 4030, can use the batteries to heat the heating elements. The amount of battery power used for heat can be based on the availability of solar energy and/or the second source of energy as well as the relative cost of using battery power. In some embodiments, the controller 4030 communicates with the batteries directly to supply power to heating elements 4010.

Thermal Energy Storage Substance (TESS)

The selection of the TESS 4015 can be based on the desired input temperature for the formation 4090 surrounding the heating well 4010. For example, in an in situ process, the TESS 4015 can have a melting temperature close to the desired temperature required to convert kerogen in the formation into hydrocarbons and liquid. In such embodiments, in situ process conditions for heating wells operate at approximately 400° C.-450° C. (whereas ex situ retorting heating wells operate at 500° C.).

Other factors can influence the selection of the characteristics for the TESS 4015 located in the heating well 4010. For example, the TESS 4015 can be selected to be low cost, readily available, low in undesirable chemical reaction potential across the potential range of temperatures encountered in its use, low toxicity, highly stable through decades of daily phase change and temperature swings, low in corrosive action to the materials used for well construction, limited in potential for contamination or degradation based on contact with materials of well construction, and/or limited in dimensional change upon solidification. Additional considerations include the heat transfer coefficient of the TESS 4015 in its solid and liquid states and its behavior when exposed to water, petroleum and/or other hydrocarbons, other thermal conductivity (e.g., the thermal conductivity of the heating element and/or the thermal conductivity of the well casing), chemical compatibility with heat transfer media, and phase of matter changes (particularly gas evolution and absorption). Other considerations can include the heat capacity of the TESS material, and the heat of fusion of the TESS material, which is generally the heat associated with a solid to liquid phase change of the TESS.

Representative examples of suitable materials for the TESS 4015 include eutectics, salt hydrates, organic and non-organic materials. The TESS 4015 can be a substance with a single melting temperature or a temperature range for melting (e.g., a solid solution with a melting temperature range). In some embodiments, the TESS 4015 can be ternary chloride eutectic mixtures (NaCl (e.g., with a melting point of 396° C.) —KCl—MgCl₂), ternary carbonate eutectic mixtures (Li₂CO₃ (e.g., with a melting point of approximately 400° C.) —K₂CO₃—Na₂CO₃), ternary fluoride salts (FLiNaK), and carbonate/sulfate eutectics (Li₂CO₃ (e.g., with a melting point of approximately 500° C.), Na₂SO₄). The potential environmental effect of the material (e.g., its toxicity) will typically be one of several factors used in the selection process. Other representative factors include the cost and availability of the material, the carbonate constituents of the material (as carbonates decompose at higher temperatures), and the geochemistry of the surrounding formation, which affects the chemical compatibility with the TESS. Table 1 includes other example TESS materials and associated chemical properties.

TABLE 1
Example TESS and Associated Chemical Properties

| Example TESS (mole percentage) | Melting Point (degrees C.) | Heat of Fusion (J/g) |
|---|---|---|
| LiF(16.2)—LiCl(42.0)—LiVO3(17.4)—Li2SO4(12.8)—Li2MoO4(11.6) | 363 | 284 ± 7 |
| LiF(20)—LiOH(80) | 427 | 1163 |

FIGS. 5A-5C illustrate partially schematic, cross-sectional side views of heating wells containing the TESS 4015 and used to heat formations in accordance with multiple embodiments of the present technology. In FIG. 5A, the heating element 4020 includes a pipe within the heating well 4010. The pipe can contain a fluid heated by the processing unit 4040 (FIG. 4). The fluid can flow through the heating well 4010 and conduct heat to the formation 4090 via the TESS 4015. In some embodiments, the TESS 4015 has a melting temperature that matches the desired process input temperature (e.g., the target temperature to which the formation is to be heated). In this manner, the system achieves roughly isothermal conditions at the outer boundary of the heating well 4010, despite wide-ranging instantaneous heat flux levels delivered by the heating element 4020.

FIG. 5A shows a single conduit that carries heated fluid. In other embodiments, the heating well 4010 can include multiple conduits (e.g., pipes). In some embodiments, the heating well 4010 can contain multiple conduits that are positioned in parallel. The diameter of each conduit can vary to increase or decrease the heat transfer rate from the conduits into the TESS 4015 and subsequently the formation 4090. Additionally, in some embodiments, the controller 4030 (FIG. 4) is configured to individually control the flow rate of heated fluid through different conduits. For example, the controller 4030 can increase a flow rate of heated fluid in pipes on the outer portion of the heating well relative to a flow rate of heated fluid in pipes on the inner portion of the heating well. One advantage of multiple conduits is that they can provide more surface area for heat exchange and therefore a higher heat transfer rate. Conversely, more conduits may be more expensive, and accordingly, using a single conduit as a heating element may be less expensive, while still being sufficient to heat the formation, albeit at a lower rate.

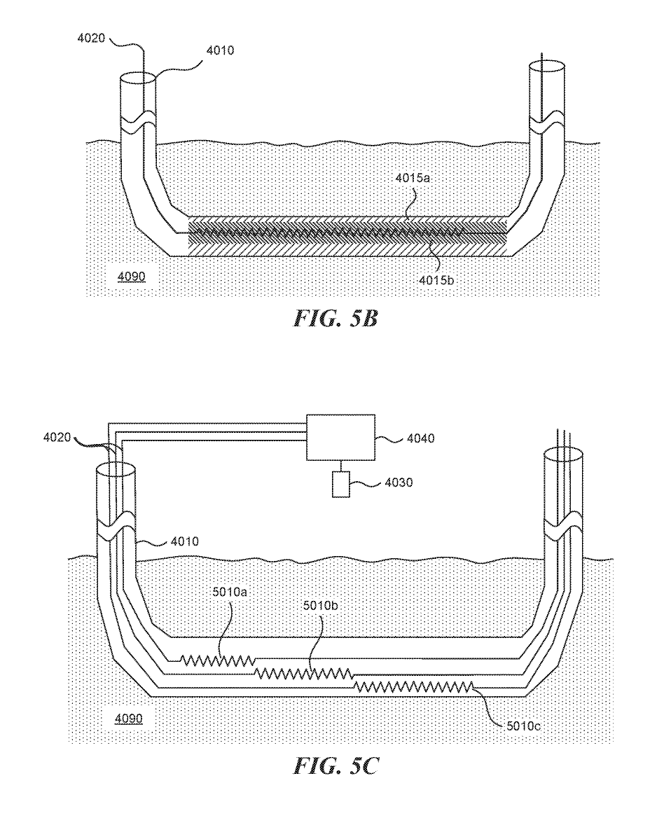

FIG. 5B illustrates an embodiment of a heating well 4010 having an electrical heating element 4020. For example, as described below and shown in more detail in FIGS. 6A-6C, the heating element 4020 can heat the TESS 4015 to the TESS melting temperature. As shown in FIG. 5B, the solid TESS 4015a (shown with diagonal hatching) begins to melt, forming liquid TESS 4015b (shown with diagonal hatching that is denser than the diagonal hatching for solid TESS 4015b). The heating element 4020 can maintain the temperature of the heating well 4010 near the melting temperature of the solid TESS 4015a. The amount of solid TESS 4015a and liquid TESS 4015b may vary with increases or decreases in the temperature of the heating element 4020 and heat lost to or gained from the surrounding formation 4090. In general, the heating element 4020 can maintain the temperature of the heating well 4010 close to (e.g., within 2° C.-3° C. of) the melting point of the solid TESS 4015a. If the temperature of the heating well 4010 is close to the melting point, the heating well 4010 can remain generally isothermal during the heat transfer process. In particular, as heat melts the solid TESS 4015a near the heating element 4020, the liquid TESS 4015b can transfer heat to the solid TESS 4015a farther away from the heating element 4020. The outer wall of the heating well 4010 heats up through conduction, and the outer wall heats the formation 4090. In some embodiments, the heating element 4020 can supply enough heat to melt all of the solid TESS 4015a, and the heating element 4020 can continue to heat the liquid TESS 4015b. In such embodiments, the liquid TESS 4015b will gain sensible heat from the heating element 4020 and will increase in temperature. In at least some embodiments, it is expected to be beneficial to keep at least some solid TESS 4015a (e.g., adjacent to the formation 4090) to preserve an isothermal heat transfer condition at the interface between the solid TESS 4015a and the formation 4090.

Configuration of Heating Elements for Solar Energy Source

In some embodiments, PV cell(s) (also referred to as “solar collectors”) can be used to collect solar energy and output electrical power. A PV cell's maximum power point (MPP) (e.g., the point at which a PV cell outputs the maximum power) can vary with environmental conditions. For example, the MPP can vary with the temperature of the PV cell (e.g., with increasing temperature increasing the resistance of the PV cell) and/or the load resistance (e.g., the resistance of a heating element or several heating elements connected to the PV cell). While there are several methods (e.g., MPP tracking algorithms, and/or current-voltage plots/curves) for calculating an MPP, in order to approach or reach the MPP for varying environmental conditions, the system should apply the proper resistance (e.g., load) to the PV cell.

One embodiment for operating a PV cell near or at its MPP is shown in FIG. 5C. FIG. 5C illustrates a heating well 4010 with heating elements 4020 arranged in parallel. The heating elements 4020 can have varying zones of resistance 5010a-c. The controller 4030 can use control circuits (e.g., switches or programmed instructions) to connect and/or disconnect individual heating elements 4020 and/or increase or decrease the power supplied to the heating elements 4020. For example, the controller 4030 and the processing unit 4040 can increase the voltage or current supplied to a heating element 4020 from non-solar energy sources when the amount of available sunlight has decreased. Furthermore, the controller 4030 can calculate a load that increases (e.g., optimizes) the power output from a PV cell or PV cells based on the connected load (e.g., the number of heating elements 4020 connected or the resistance detected in the heating elements 4020). The controller 4030 may use several methods for calculating an MPP, and the methods can use the following factors in this calculation: power (irradiance level), voltage (temperature), fluctuations (clouds), current-voltage curves (e.g., shape and derivative of the V-I curve), open-circuit voltage and short circuit-current (e.g., open-circuit voltage and short-circuit current for an ideal PV cell), and field measurements (e.g., actual output voltage) versus theoretical values. As another example, the processing unit 4040 and/or the controller 4030 may disconnect some heating elements 4020 in the morning (due to less sunshine) and connect some heating elements 4020 at noon (due to more sunshine) to provide an electrical resistance that is commensurate with the available power.

FIGS. 6A-6C illustrate cross-sectional views of a heating well configured in accordance with embodiments of the present technology. In general, solar energy can provide energy to the heating element 4020 (e.g., via the processing unit 4040 and controller 4030 shown in FIGS. 4 and/or 5C) at a time-varying rate due to the availability of sunshine. Heat delivered into the heating element 4020 heats the solid TESS 4015a up to its melting temperature and melts the solid TESS 4015a into liquid TESS 4015b in a generally isothermal process. As heat delivery continues even after the solid TESS 4015a proximate to the heating element 4020 melts, that proximate material heats the solid TESS 4015a material farther from the heating element 4020 up to the melting temperature. In this way, during times that solar energy is available, the melting process proceeds radially outward from the heating element 4020. The melted TESS transfers heat outwardly, via conduction and convection, allowing the high heat flux from the heating element 4020 to be carried outward. Accordingly, heat flows outwardly from the outer boundary of the heating well 4010 into the surrounding formation 4090.

In some embodiments, the heating element 4020 includes a pipe conveying a heated fluid, and in other embodiments the heating element 4020 includes an electrically conductive material (e.g., a metal alloy wire) conveying electrical current. Beginning with FIG. 6A, in a representative fluid-based example, the heating element 4020 includes a pipe within the heating well 4010, and the pipe contains a working fluid having a viscosity and freezing temperature suitable for heating the surrounding formation 4090. In some embodiments, the heating element 4020 can be in the center of the heating well 4010 and can direct heat 6000 (represented by a bold arrow and associated with heat flux “q₁”) to the outer wall 6010 of the heating well 4010. The outer wall 6010 of the heating well 4010 can be formed by a casing (e.g., a metal, a composite metal, and/or a heat-treated plastic casing). In some embodiments, the outer wall 6010 includes fins, baffles, or jagged edge configurations, e.g., to facilitate heat transfer into the formation 4090. The outer wall 6010 can be selected based on desired heat transfer properties and formation conditions. In FIGS. 6A-6C, T₀ represents the temperature of the heating element 4020, T₁ represents the temperature of liquid TESS between the heating element 4020 and the outer wall 6010, T₂ represents the temperature of solid TESS between the heating element 4020 and the outer wall 6010, and T₃ represents the temperature of the surrounding formation.

In FIG. 6A, the solid TESS 4015a is indicated by less dense diagonal hatching than the diagonal hatching for liquid TESS 4015b in FIG. 6B. FIG. 6B illustrates what occurs when the solid TESS 4015a melts to form liquid TESS 4015b. Melting occurs in response to the processing unit 4040/controller 4030 (FIGS. 4 and/or 5C) increasing the flow of current or heated fluid passing through heating element 4020. Furthermore, the processing unit can increase or decrease the temperature of the heating element 4020 in several ways to regulate the rate at which the solid TESS 4015a melts. For example, if the heating element 4020 is or includes an electrical heating element, the processing unit 4040 and/or controller 4030 can increase or decrease the flow of current or voltage directed to the heating element. If the heating element is or includes a pipe conveying a working fluid, the processing unit/controller can increase or decrease the flow of the working fluid and/or the temperature of the working fluid. In some embodiments, the processing unit 4040 controls both the flow and temperature of a fluid that is passing through the heating element 4020. As the temperature of the heating element 4020 rises, the solid TESS 4015a heats and begins to melt as it attains the melting temperature (T₁). As the solid TESS 4015a melts, the space between the heating element 4020 and the outer wall 6010 contains both solid TESS 4015a and liquid TESS 4015b, as shown in FIG. 6B. In some embodiments, the processing unit 4040 operates the heating element 4020 to maintain the temperature of the heating element 4020 (T₀) close to the melting temperature of the solid TESS 4015a (T₁), which can absorb heat as heat of fusion. The ratio of solid TESS 4015a to liquid TESS 4015b can vary depending on the chosen heating element and its properties, such as conduction, resistance, position, etc.

As shown in FIG. 6C, the heating element 4020 has heated most of the solid TESS 4015a to its melting temperature. The volume occupied by the liquid TESS 4015b will grow or shrink, depending on factors including the amount of heat 6000 supplied by the heating element 4020, and the temperature T₃ of the formation 4090 surrounding the heating well 4010. For example, if the processing unit 4040 (FIG. 4) uses solar energy to supply heat to the heating element 4020, then, during evening hours, the volume of liquid TESS 4015b will shrink if no other energy is supplied to the heating element 4020. The processing unit 4040 can use an alternative source of energy such as natural gas to increase the volume of liquid TESS 4015b for continued heat transfer to the formation 4090. In other embodiments, the volume of liquid TESS 4015b can decrease, but not to the point at which the entire volume of TESS 4015 becomes solid. As the liquid TESS 4015b solidifies, it gives up heat to the formation 4090. Once the TESS becomes completely solid TESS 4015a, it begins absorbing heat from the formation 4090 (absent further heating), which is why it can be desirable to maintain at least some of the TESS in liquid form.

In the steady state, T₀ can be slightly higher than T₁ to offset heat lost due to conduction from the heating element 4020 to the liquid TESS 4015b. In the steady state, because T₁=T₂ and the heating element 4020 is supplying a nearly constant heat flux, heat transfer into the formation remains isothermal. In general, so long as there is enough residual heat in the heating well 4010 that a portion of the liquid TESS 4015b remains in a liquid phase and a portion of the solid TESS 4015a is in solid phase, the heating well 4010 delivers heat to the retorting process (e.g., conducts heat into the formation 4090) at approximately isothermal conditions.

In general, the thermal resistivity of the solid TESS 4015a and the thickness of the solidified TESS layer can be factors in the heat transfer rate into the formation 4090. For example, in some embodiments, relatively low thermal conductivity of the TESS 4015 can be addressed via a mixed media bed (possibly including a high-temperature liquid), encapsulating the chemical reactants within a matrix of higher thermal conductivity solid media, and/or expanding the surface area of the heating element 4020 with high-conductivity “fins” or other conductive heat transfer-enhancing features.

The presence of the solid and liquid TESS 4015a-b inside the heating well 4010 can offer one or more of several advantages. For example, the presence of the liquid TESS 4015b surrounding the heating element 4020 creates a uniform heat transfer coefficient, θₕₘ, into the solid TESS 4015a, which can reduce or eliminate the potential for “hot spot” formation associated with electrically heated formations. The uniformity of θₕₘ can allow the manufacturer/operator to select lower-cost materials when constructing the electrical heating element by reducing or removing the requirement for low thermal resistivity material, as discussed above. In addition, melting the solid TESS 4015a significantly increases the total energy storage per unit of media (kJ/kg), without requiring the high temperatures that would be required to achieve a similar energy storage via sensible heat. As a result, the net thermal efficiency of the solar thermal collectors can be increased because the energy can effectively be collected at temperatures closer to the retorting process temperature. Put another way, the temperature of the working fluid delivered to the heating element 4020 and the phase change temperature of the TESS 4015 can be near the retort process temperature to reduce thermal inefficiencies due to large temperature differences.

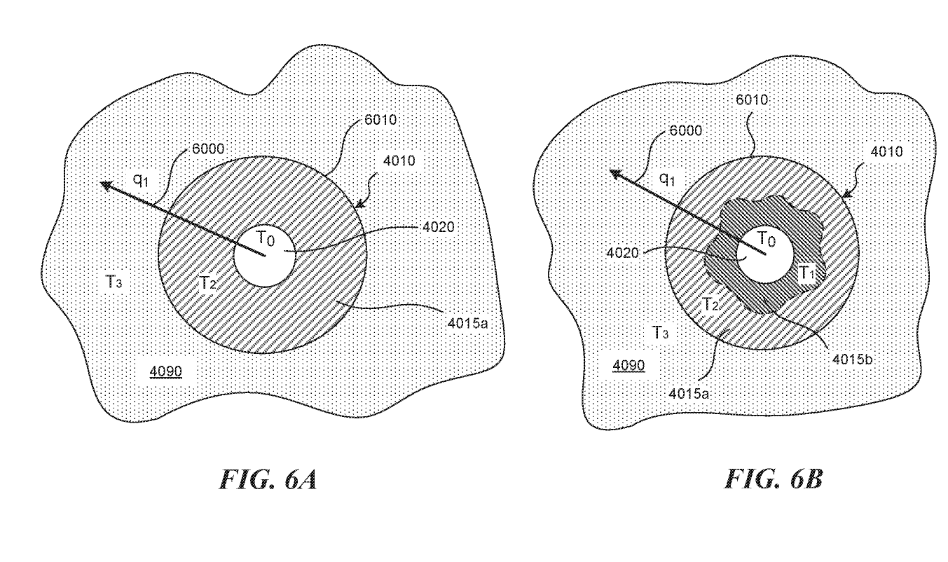

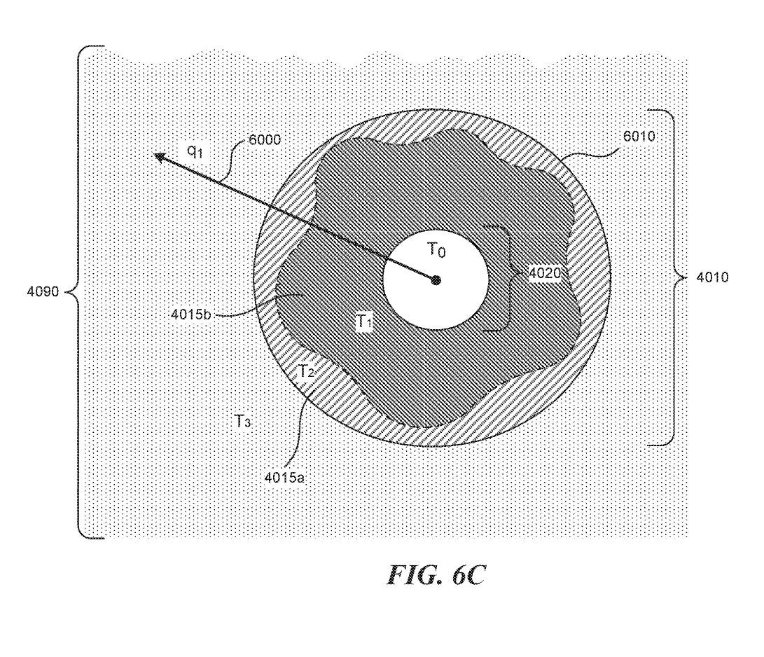

FIGS. 7A-7B illustrate a cross-sectional view of a heating well 4010 and the corresponding temperature profile in accordance with an embodiment of the present technology. As discussed above, T₀ corresponds to the temperature of the heating element 4020, T₁ corresponds to the temperature of the liquid TESS 4015b between the heating element 4020 and the outer wall 6010, T₂ corresponds to the temperature of the solid TESS 4015a between the heating element 4020 and the outer wall 6010, and T₃ corresponds to the temperature of the surrounding formation 4090. Heat 7000 is represented by a bold arrow and associated heat flux indicator “q₂”, which represents the heat flux from the surrounding formation 4090 to the heating well 4010. In some embodiments, the heat flux q₂ is minimal, negative, or zero because the heating well 4010 is heating a cooler surrounding formation 4090. At steady state, the formation 4090 cools the outer wall 6010 at a rate equal to the rate at which the heating element 4020 heats the solid TESS 4015a and liquid TESS 4015b.

In FIG. 7B, the x-axis indicates the distance from the center of the heating element 4020 (e.g., the center of a pipe conveying a working fluid, or the center of an electric heater) into the formation 4090. As shown in FIG. 7B, the temperature drops at each transition can be due to the inefficiency in heat transfer at each material boundary (e.g., transferring heat from the heating element 4020 to the liquid TESS 4015b).

Chemically Reactive Thermal Energy Storage Substance in Heating Well

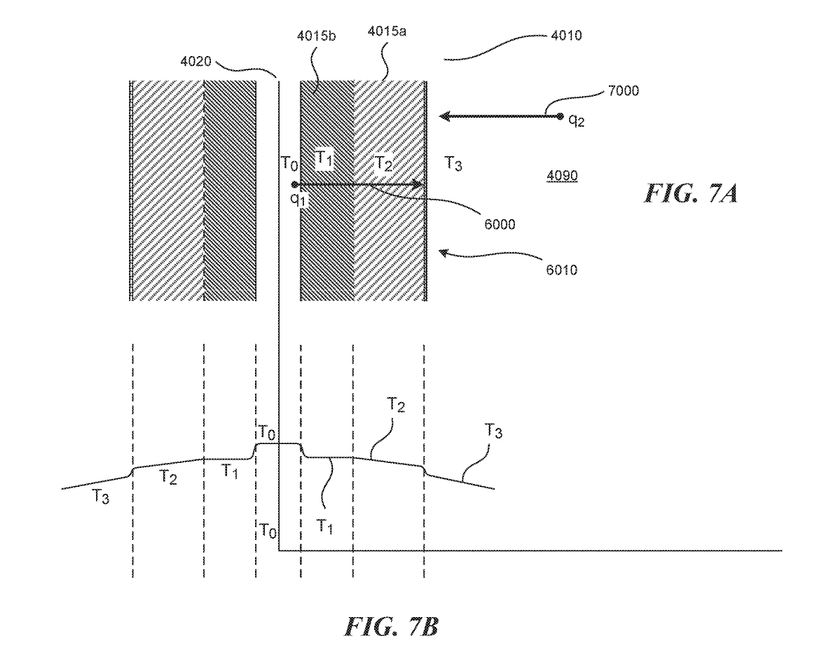

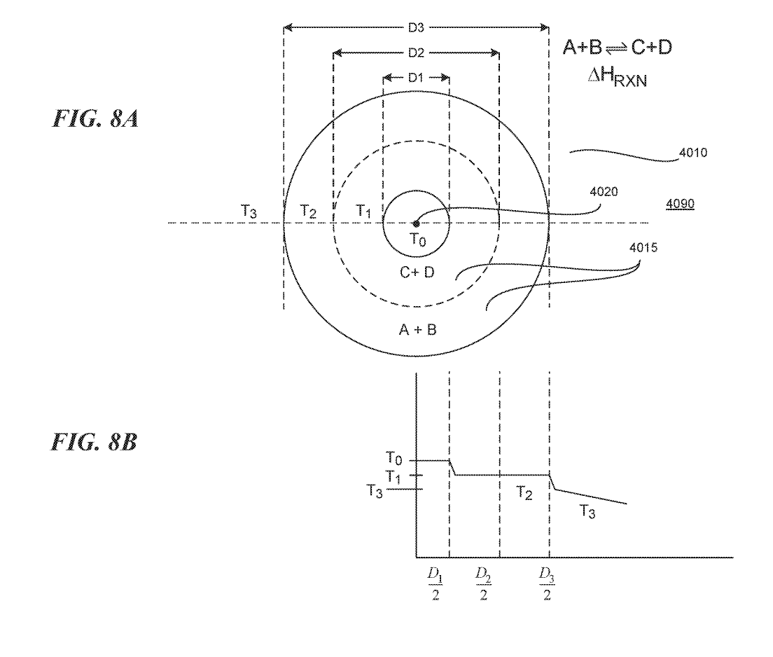

FIG. 8A illustrates a partially schematic, cross-sectional view of a heating well 4010 with a TESS 4015. Here, the TESS 4015 is composed of “A+B” (two chemicals), and is heated to a chemical reaction temperature in which “A+B” is converted to “C+D.” The chemical reaction temperature can be calculated using Arrhenius's equation and equilibrium constants (e.g., K=[C][D]/[A][B]). In some embodiments, the forward reaction rate (e.g., an endothermic reaction A+B+Heat→C+D) and the reverse reaction rate (e.g., an exothermic reaction C+D→A+B+Heat) are in equilibrium. In such embodiments, the heating element 4020 can increase the heat supplied to the TESS 4015, which will drive the forward reaction (e.g., the endothermic reaction A+B+Heat→C+D) and slow the reverse reaction (e.g., the exothermic reaction C+D→A+B+Heat). Accordingly, the operator can regulate the output of the heating element 4020 to affect the chemical equilibrium (e.g., K=[C][D]/[A][B]), which can also affect the formation of A+B and C+D.

FIG. 8B illustrates the corresponding temperature profile in accordance with an embodiment of the present technology. When the reactions are in equilibrium, a roughly isothermal condition can be achieved at the outer boundary of the heating well 4010, despite a widely ranging instantaneous heat flux delivered by the heating element 4020. While four different chemical species (A, B, C, and D) are shown in FIG. 8A, other embodiments can include a single chemical (e.g., A) transitioning to a single chemical (e.g., A with a different chemical structure), or other suitable combinations (e.g., A⇄B+C; A+B+C⇄D+E+F, disassociation reactions, hydration or dehydration reactions, or oxidation/reduction reactions). Representative examples of TESS reactions include dehydration (e.g., CaCl₂*6H₂O [symbol] CaCl₂+6H₂O), hydroxide/oxide reactions (e.g., (Ca(OH)₂ [symbol] CaO+H₂O), and redox reactions. These reactions can be particularly suitable because the reactants are relatively inexpensive and chemically benign, and have a working temperature of approximately 500° C.

As shown in FIG. 8A, the diameter of the heating element 4020 is D1, the diameter of the area closest to the heating element 4020 is D2, and the diameter of the heating well 4010 is D3. FIG. 8B illustrates a corresponding temperature profile. In FIG. 8B, the x-axis represents the distance from the center of the heating element 4020 to and into the formation 4090. The y-axis is the temperature (e.g., degrees Celsius, degrees Fahrenheit, degrees Kelvin). As shown in FIGS. 8A-8B, if the heating well is at steady state (e.g., the endothermic reaction A+B→C+D and the reverse exothermic reaction C+D→A+B are in equilibrium), then T₁=T₂. Also, as shown in FIG. 8B, from the heating element 4020 to the TESS 4015, there is a decrease in temperature due to the material properties of the heating element 4020 and heat conduction. In other embodiments, the temperature profile can be different than that shown in FIG. 8B (e.g., the profile can have a more gradual or more rapid change of temperature from region to region) depending on the heating element and/or the TESS used in the process.

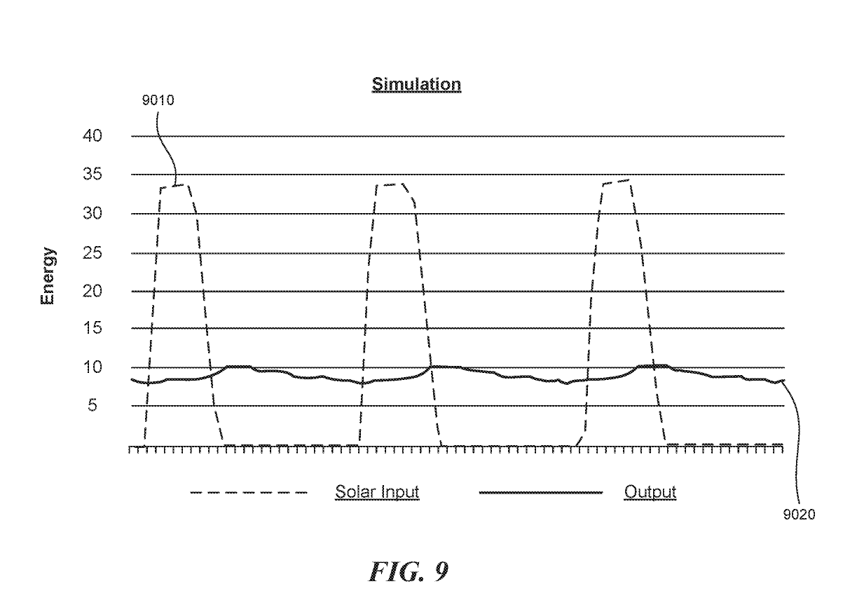

FIG. 9 is a graph illustrating results of a simulation of an embodiment of the present technology in a solar environment. In this simulation, solar energy drives an in situ retorting process by delivering energy at a time-varying rate based on the availability of sunshine. Solar energy is shown by a dashed line 9010, and the output energy delivered to the formation by the TESS as a result of solar heating is shown by a solid line 9020. The representative energy levels on the y-axis are in units of MMBTU/h and the x-axis increments are in hours. Accordingly, FIG. 9 illustrates three 24-hour periods. As is shown in FIG. 9, the heat output of the TESS is generally uniform, despite the significant variance in solar input energy.

From the foregoing, it will be appreciated that specific embodiments of the present technology have been described herein for purposes of illustration, but that various modifications may be made without deviating from the technology. For example, other sources of energy such as geothermal energy can be used to heat a TESS. As another example, the solar collectors described above can include linear concentrating mirrors, linear Fresnel concentrators, concentrator towers, and/or dish concentrators, among others. The media used to transfer heat within the system can include encapsulated substances other than those described above. For example, such media can include a micro-encapsulated phase change material (PCM) slurry, which can fill the well to produce efficient thermal transfer to the surrounding formation. In particular embodiments, the chemical reaction processes may be conducted over the course of multiple stages, each at a different process temperature. Accordingly, individual wells can include different PCM slurries (or other PCM compositions) that maintain the proper process temperature for each chemical reaction.

In yet another embodiment, the PCM slurry can be circulated as the heat transfer fluid itself. Accordingly, it can be stored in a tank where it receives heat from the solar field, and the well can be filled with any suitable fluid. The well can be readily filled with such fluids (e.g., liquid-phase fluids) and the tank at the surface can offer an automatic storage suitable for nighttime operation (e.g., by having a capacity suitable for overnight operations). The capacity can also account for variations in solar insolation (e.g., a string of cloudy days). The slurry (e.g., small encapsulated and suspended quantities of PCM material in a liquid matrix) does not have the potential thermal transfer drawback that a bulk PCM may have because the liquid is highly thermally conductive, unlike the solid PCM “wall” that can be created by solid TESS (e.g., as shown in FIG. 6C). As a result of the liquid portion of the slurry, the heat from the pipe is effectively transferred to the outer wall as a result of both conduction and convection.

In some embodiments for which the TESS includes a PCM slurry, the slurry can include multiple PCM substances with various chemical and physical properties. For example, one PCM substance in the slurry can have a higher melting point (e.g., 250 degrees Celsius) than another PCM substance (e.g., 210 degrees Celsius). As such, the disclosed technology can heat a TESS that includes a PCM slurry over a range of temperatures, where the range includes the melting point of some (e.g., all) PCMs included in the slurry (in the above example, a range from 205 degrees Celsius to 255 degrees Celsius). Although the process of heating a TESS that includes a PCM slurry may not be an isothermal process throughout the temperature range, the advantages discussed above related to a steady heating rate and heat of fusion for the TESS are still present because at the melting point for each PCM in the slurry, at least part of the slurry will undergo a generally isothermal process.

The present disclosure includes at least three different embodiments of TESS: a TESS with a single melting or chemical reaction temperature, a TESS with a melting or chemical reaction temperature range, or a TESS including a slurry or other combination of PCMs with individual PCMs having different melting temperatures. Although these different embodiments of a TESS can behave differently or cost different amounts, the different TESS embodiments have at least one advantage in common: heat transfer associated with latent heat or endothermic and exothermic heat associated with a chemical reaction. This common advantage enables steady heat transfer because operating a heating process associated with latent heat or endothermic/exothermic heat can reduce hot spots, large fluctuations in heat flux, and/or large fluctuations in temperature changes.

Several of the techniques described in detail herein can be embodied as special-purpose hardware (e.g., circuitry), programmable circuitry appropriately programmed with software and/or firmware, or a combination of special-purpose and programmable circuitry. Hence, embodiments can include a machine-readable medium having stored thereon instructions that may perform, or be used to program a computer (or other electronic devices) to perform, one or more of the processes described above. The machine-readable medium can include, but is not limited to, optical disks, compact disc read-only memories (CD-ROMs), magneto-optical disks, read-only memory (ROM), random access memory (RAM), erasable programmable read-only memories (EPROMs), electrically erasable programmable read-only memories (EEPROMs), magnetic or optical cards, flash memory, or other types of media/machine-readable mediums suitable for storing electronic instructions. Some embodiments can include a machine-readable medium having stored thereon instructions that when executed by a processor cause a device to perform a process or processes described in this Detailed Description.

Certain aspects of the technology described in the context of particular embodiments may be combined, or they may be eliminated in other embodiments. For example, if solar power becomes unavailable for an extended period of time, the processing unit can exclusively use electrical power to heat a heating well. Further, while advantages associated with certain embodiments of the disclosed technology have been described in the context of those embodiments, other embodiments may also exhibit such advantages, and not all embodiments need necessarily exhibit such advantages to fall within the scope of the present technology. Accordingly, the present disclosure and associated technology can encompass other embodiments not expressly shown or described herein. For example, the heat delivery system, including the TESS, can also be used in a chemical process (e.g., a water treatment plant process or a hydrocarbon cracking process) for maintaining generally isothermal conditions.

To the extent any materials incorporated herein by reference conflict with the present disclosure, the present disclosure controls.

I/We claim:

1. A method for delivering heat to a subsurface location, comprising:
transferring solar energy to a working fluid via multiple solar collectors;
directing the working fluid through a loop to at least partially transfer energy from the working fluid to a subsurface heating well,
wherein the loop at least partially extends through the subsurface heating well, and
wherein the subsurface heating well contains a thermal energy storage substance (TESS) positioned between the working fluid and an outer casing of the subsurface heating well; and
controlling a flow of the working fluid to cause the TESS to undergo at least a partial phase change at at least one phase change temperature or a partial chemical change at at least one chemical change temperature.

2. The method of claim 1, wherein a sufficient amount of TESS is positioned between the working fluid and the outer casing of the subsurface heating well to reduce temperature variation in heat exchange between the outer casing of the subsurface heating well and a portion of a formation surrounding the subsurface heating well.

3. The method of claim 1, wherein the controlling the flow of the working fluid causes the temperature of the TESS to be within 20 degrees Celsius of the at least one phase change temperature or within 20 degrees Celsius of the at least one chemical change temperature.

4. The method of claim 1, further comprising:
receiving energy from a non-solar energy source; and
transferring energy from the non-solar energy source to the working fluid,
wherein transferring energy from the non-solar energy source is performed at least partially based on relative availability of solar energy and non-solar energy, and
wherein the non-solar source of energy is at least one of the following: wind, electrical energy from a grid during off-peak times, electrical energy from a grid, natural gas, or any combination thereof.

5. The method of claim 1, further comprising:
receiving energy from a non-solar energy source; and
transferring energy from the non-solar energy source to the working fluid.

6. The method of claim 1, wherein the TESS has a phase change temperature above 250 degrees Celsius.

7. The method of claim 1, further comprising:
directing the working fluid through a heat recycling unit after the working fluid has passed through at least a portion of the subsurface heating well; and
transferring thermal energy from recycled working fluid into the in situ process.

8. A method for heat transfer, comprising:
collecting solar energy;
converting the solar energy into electrical energy; and
transferring at least some of the electrical energy to an electrical heating element inside a conduit,
wherein the conduit carries a thermal energy storage substance (TESS), and
wherein the TESS is positioned between the electrical heating element and a casing of the conduit.

9. The method of claim 8 wherein the electrical heating element is a first electrical heating element, and wherein the method further comprises:
transferring at least some of the electrical energy to a second electrical heating element inside the conduit,
wherein the second electrical heating element is spaced apart from and electrically connected in parallel to the first electrical heating element,
wherein the first electrical heating element has a first zone with a first electrical resistance, and
wherein the second electrical heating element has a second zone with a second electrical resistance different than the first; and
increasing power supplied to at least one of the first or second electrical heating elements to heat the TESS in thermal communication with the at least one of the first or second electrical heating elements.

10. The method of claim 9, further comprising:
receiving energy from a non-solar energy source; and
transferring energy from the non-solar energy source to at least one of the first or second electrical heating elements.

11. The method of claim 9, further comprising:
increasing or decreasing electrical power supplied to at least one of the first or second electrical heating elements to control a temperature of the TESS to be within 3 degrees Celsius of a phase change temperature of the TESS.

12. The method of claim 8, wherein the conduit at least partially extends through a heating well, and wherein the heating well is located in a kerogen-bearing formation.

13. The method of claim 8, wherein the conduit is located in a chemical processing plant, and wherein converting the solar energy into electrical energy is carried out by a photovoltaic (PV) cell.

14. The method of claim 8, wherein the TESS has a melting temperature range or a chemical change temperature range.

15. The method of claim 8, further comprising:
delivering the TESS into the conduit by controlling a flow of pressurized flowing air carrying a pelletized solid TESS material into the conduit.

16. A heating system, comprising:
multiple solar concentrators positioned to focus solar energy on a receiver, the receiver carrying a working fluid;
a subsurface heating well;
a heating element positioned at least partially inside the subsurface heating well;
a thermal energy storage substance (TESS) in thermal communication with the heating element; and
a controller configured to adjust a temperature of the heating element based at least in part on a target temperature that causes the TESS to change in phase at at least one phase change temperature or undergo a chemical reaction at at least one chemical change temperature.

17. The heating system of claim 16, wherein the TESS is positioned between the heating element and an outer casing of the subsurface heating well.

18. The heating system of claim 16, wherein the heating element includes an electrical heating element.

19. The heating system of claim 16, wherein the heating element includes a working fluid carried inside a conduit.

20. The heating system of claim 16, wherein the TESS includes a mixture of gas diffused in a liquid.

21. A heating system, comprising:
a controller configured to:
control a temperature of a heating element in a subsurface heating well to cause at least a partial phase change in a thermal energy storage material (TESS) positioned in the subsurface heating well,
wherein the TESS is positioned between the heating element and an outer casing of the subsurface heating well.

22. The heating system of claim 21, wherein the controller is configured to:
receive maximum power point (MPP) information from photovoltaic cells;
modify power supplied to the heating element based at least in part on the received MPP information,
wherein modifying includes supplying more power to the heat element to cause the TESS to absorb heat.

23. The heating system of claim 21, wherein the controller is configured to:
receive a first input corresponding to an availability of solar energy;
receive a second input corresponding to an availability of non-solar energy; and
modify an amount of non-solar energy used to heat the heating element based at least in part on the first and second inputs.

24. The heating system of claim 21, wherein the controller is configured to:
receive an input corresponding to a temperature of the heating element; and
modify electrical power supplied to the heating element based at least in part on the input.

25. A heating apparatus, comprising:
a solar energy collection component; and
a controller configured to adjust a target temperature of a heating element based at least in part on at least one temperature that causes a thermal energy storage substance (TESS) to change phase or undergo a chemical reaction,
wherein the TESS is positioned between the heating element and an outer casing of a conduit,
wherein the conduit is in thermal communication with a chemical reactor or chemical processing component; and
wherein the heating element is at least partially heated by the solar energy collector.

26. The heating apparatus of claim 25, further comprising:
a processing unit configured to transfer thermal energy from a working fluid to the heating element,
wherein the working fluid is in thermal communication with the solar energy collection component,
wherein the processing unit is further configured to receive energy from a second energy source and use the energy from the second energy source to further heat the working fluid, and
wherein the processing unit is coupled to the controller to receive instructions from the controller.

27. The heating apparatus of claim 25, wherein the solar energy collection component includes at least one of the following: multiple photovoltaic cells or multiple solar concentrators configured to focus solar energy on a collector carrying working fluid.

28. A non-transitory computer-readable medium storing instructions that, when executed by one or more processors, cause the one or more processors to:
monitor an availability of thermal or electrical energy converted from solar energy;
adjust a temperature of a heating element in thermal communication with a subsurface thermal energy storage substance (TESS),
wherein adjusting the temperature of the heating element is based at least in part on at least one melting temperature or at least one chemical change temperature of the TESS, and an availability of converted solar energy.

29. The non-transitory computer-readable medium of claim 28, wherein the subsurface TESS is positioned between the heating element and an outer casing of a conduit, and wherein the conduit is in thermal communication with a chemical reactor or chemical processing component.

30. The non-transitory computer-readable medium of claim 28, wherein the instructions cause the one or more processors to:
receive a temperature measurement from a thermocouple in thermal communication with the heating element;
receive a first input corresponding to an availability of solar energy;
receive a second input corresponding to an availability of non-solar energy; and
determine how much solar and non-solar energy to use to adjust the temperature of the subsurface TESS based at least in part on the temperature measurement, the first input, and the second input.
